(19) United States
(12) Patent Application Publication
(10) Pub. No.: US 2018/0031440 A1
(43) Pub. Date: Feb. 1, 2018

(54) BOP TEST APPARATUS

(71) Applicant: Nabors Drilling Technologies USA, Inc., Houston, TX (US)

(72) Inventor: Joey PEYREGNE, Spring, TX (US)

(21) Appl. No.: 15/495,528

(22) Filed: Apr. 24, 2017

Related U.S. Application Data
(60) Provisional application No. 62/366,762, filed on Jul. 26, 2016.

(51) Int. Cl. G01M 3/28; E21B 47/06; E21B 33/06

(52) U.S. Cl. CPC G01M 3/2876; E21B 33/06; E21B 47/06

(57) ABSTRACT

A BOP test apparatus may include an outer frame, a hydraulic pump, the hydraulic pump powered by an electric motor, and a charger pump, the charger pump powered by a second electric motor. The BOP test apparatus may also include a regulator, the regulator positioned to regulate the pressure of a fluid pumped by the hydraulic pump and a valve, the valve positioned to open or close fluid flow from the hydraulic pump to an outlet.

### CROSS-REFERENCE TO RELATED APPLICATIONS

This application is a nonprovisional application that claims priority from U.S. provisional application No. 62/366,762, filed Jul. 26, 2016.

### TECHNICAL FIELD/FIELD OF THE DISCLOSURE

The present disclosure relates to oilfield test equipment.

### BACKGROUND OF THE DISCLOSURE

On a drilling rig, many pieces of equipment are subjected to high pressures. Routine testing may be required before and during use of the equipment to ensure the device is functioning properly. Typically, either pneumatic, electric, or diesel power sources may be utilized. Because it uses a compressible medium, pneumatic testing may not be suitable for all pieces of equipment and pressures. Hydraulic testing may require multiple pieces of equipment, including for example multiple pumps and data collection devices, to be assembled and configured for each test.

For example, a blowout preventer (BOP) is a piece of safety equipment located at the surface which must be able to resist high pressures in the wellbore without failure. The BOP includes one or more valves and other fittings to regain control of a wellbore that has encountered a loss of control of formation fluids, such as a kick. Regular testing of the BOP and its associated components, including, for example and without limitation, choke manifolds, kelly valves, drill-string safety valves, etc., may be required by law or other regulating authority.

### SUMMARY

A BOP test apparatus is disclosed. The BOP test apparatus includes an outer frame, a hydraulic pump, the hydraulic pump powered by an electric motor, and a charger pump, the charger pump powered by a second electric motor. The BOP test apparatus also includes a regulator, the regulator positioned to regulate the pressure of a fluid pumped by the hydraulic pump and a valve, the valve positioned to open or close fluid flow from the hydraulic pump to an outlet.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a BOP test apparatus consistent with at least one embodiment of the present disclosure.

FIG. 2 is an elevation view of the BOP test apparatus of FIG. 1.

FIG. 3 is an elevation view of the side of the BOP test apparatus of FIG. 1.

FIG. 4 is a schematic view of the BOP test apparatus of FIG. 1.

FIG. 5 is a schematic view of a BOP test apparatus consistent with at least one embodiment of the present disclosure attached to a BOP and choke.

FIG. 6 is a schematic view of a BOP test apparatus consistent with at least one embodiment of the present disclosure attached to a BOP.

FIG. 7 is a partially transparent view of a BOP test apparatus consistent with at least one embodiment of the present disclosure.

FIG. 8 is a partially transparent end view of the BOP test apparatus of FIG. 7.

FIG. 9 is a partially transparent top view of the BOP test apparatus of FIG. 7.

FIG. 10 is a schematic view of the BOP test apparatus of FIG. 7.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

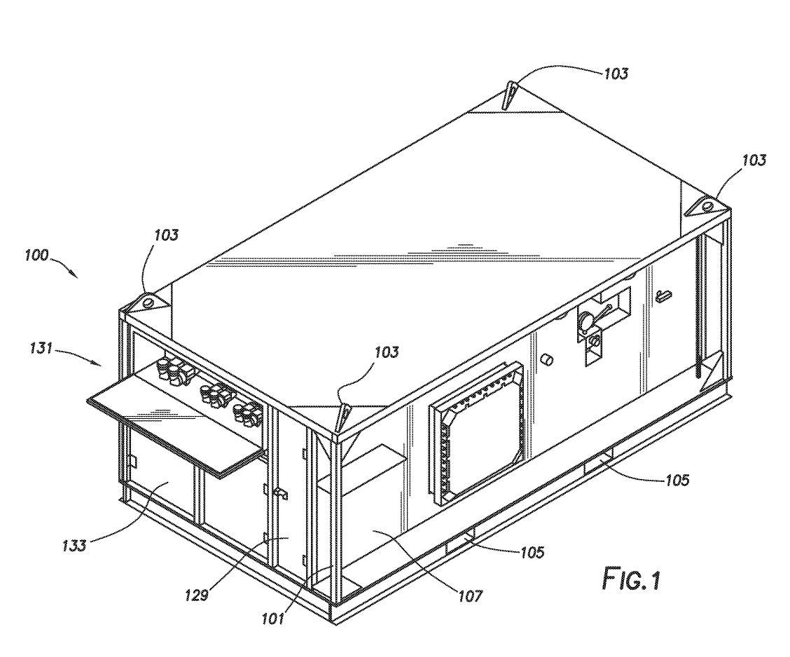

FIGS. 1-3 depict BOP test apparatus 100. BOP test apparatus 100 may include outer frame 101. In some embodiments, outer frame 101 may include one or more lift points 103 for coupling to, for example and without limitation, one or more hoisting lines for movement of BOP test apparatus 100. In some embodiments, outer frame 101 may include one or more forklift pockets 105 to, for example and without limitation, allow a forklift to lift BOP test apparatus 100. In some embodiments, outer frame 101 may be fluid tight at the bottom to, for example, contain any spills within BOP test apparatus 100.

In some embodiments, BOP test apparatus 100 may include outer walls 107. Outer walls 107 may, for example and without limitation, isolate the internal components of BOP test apparatus 100 from the surrounding environment. Outer walls 107 may, in some embodiments, include one or more access doors, control panels, or other features as discussed herein below and otherwise.

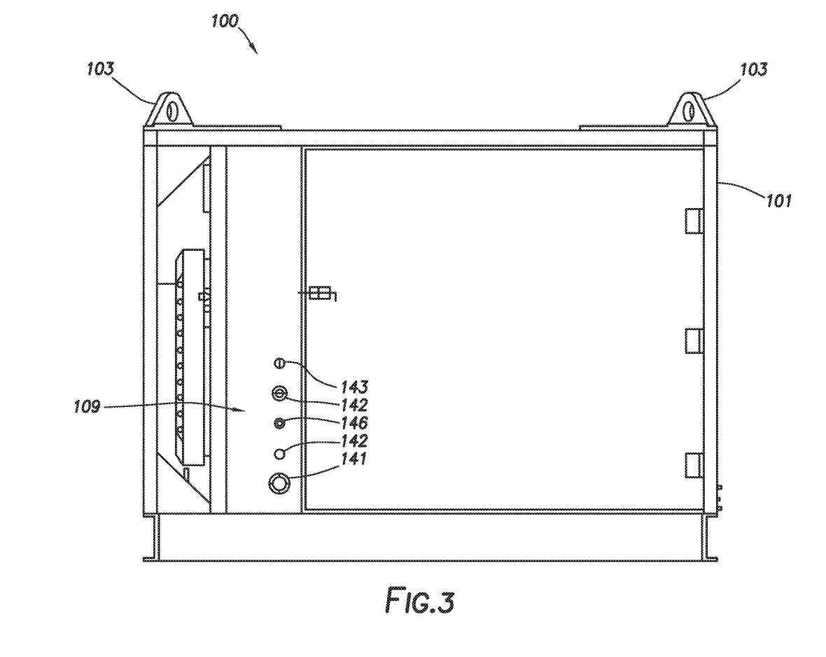

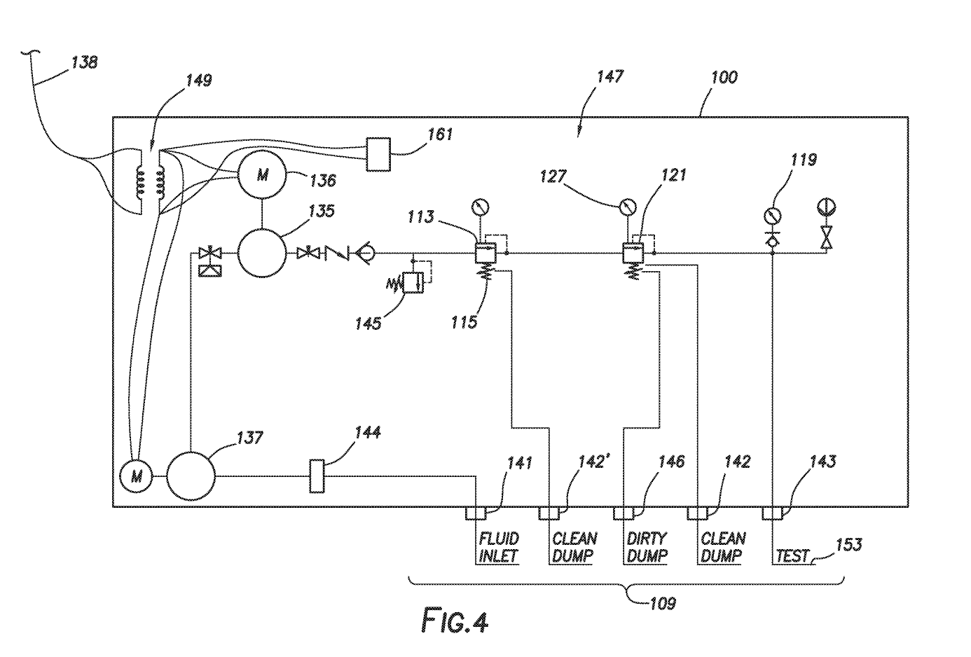

In some embodiments, as depicted in FIG. 3 and discussed further herein below with respect to FIG. 4, BOP test apparatus 100 may include hydraulic ports 109. Hydraulic ports 109 may couple to one or more hydraulic lines for supplying fluid to BOP test apparatus 100 and for hydraulic lines for routing pressurized fluid from BOP test apparatus 100.

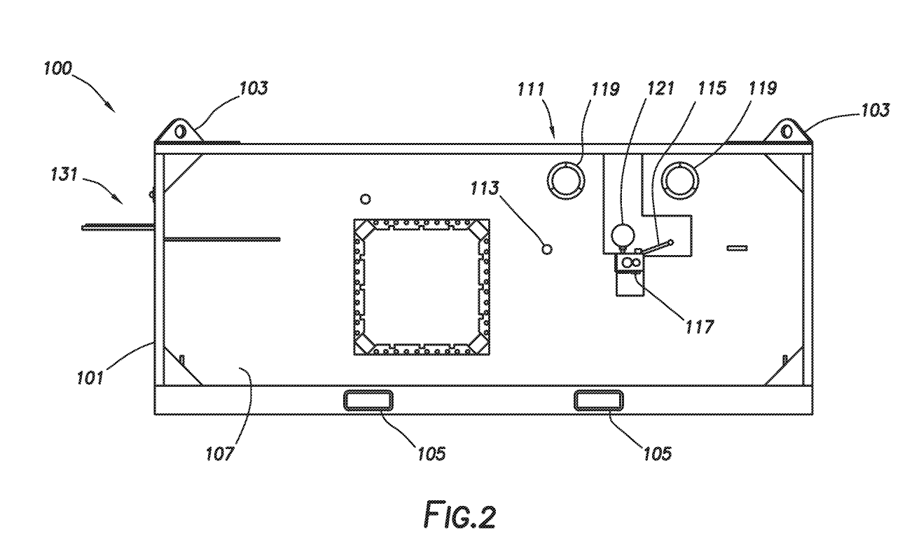

In some embodiments, as depicted in FIG. 2, BOP test apparatus 100 may include control panel 111. Control panel 111 may include controls for controlling the operation of BOP test apparatus 100. For example and without limitation, control panel 111 may include regulator 113. Regulator 113 may be used to preselect a regulated pressure for an output of BOP test apparatus 100. In some embodiments, regulator 113 may be calibrated. In some embodiments, BOP test apparatus 100 may include valve 115. Valve 115 may be fluidly coupled to allow selective fluid flow at the preselected pressure through one or more hydraulic ports 109. In some embodiments, valve 115 may include block body 117. In some embodiments, valve 115 may be an isolation valve. In some embodiments, control panel 111 may include one or more gauges for measuring and/or displaying output pressure of BOP test apparatus 100. In some embodiments, for example and without limitation, analog gauge 119 may display an output pressure to an operator. In some embodiments, digital gauge 121 may measure output pressure of BOP test apparatus 100.

In some embodiments, BOP test apparatus 100 may include one or more storage compartments. For example, BOP test apparatus 100 may include high pressure hose storage compartment 129. In some embodiments, BOP test apparatus 100 may include hydraulic wrench assembly 131. Hydraulic wrench assembly 131 may include one or more hydraulic wrenches and associated hardware. In some embodiments, BOP test apparatus 100 may include storage for mobile hydraulic pressure unit 133. Mobile hydraulic pressure unit 133 may, as understood in the art, allow hydraulic pressure to be stored and utilized at a location away from BOP test apparatus 100. In some embodiments, mobile hydraulic pressure unit 133 may be charged or powered by BOP test apparatus 100. In some embodiments, mobile hydraulic pressure unit 133 may be used to power hydraulic wrench assembly 131.

In some embodiments, as depicted in FIG. 4, BOP test apparatus 100 may include hydraulic pump 135. In some embodiments, hydraulic pump 135 may be, for example and without limitation, a triplex positive displacement pump as understood in the art. In some embodiments, hydraulic pump 135 may be powered by an electric or fossil fuel motor. Although described herein as a hydraulic pump, one having ordinary skill in the art with the benefit of this disclosure will understand that a pneumatic pump may be utilized without deviating from the scope of this disclosure. In some embodiments, hydraulic pump 135 may be driven by electric motor 136. Electric motor 136 may be run from power input 138. In some embodiments, BOP test apparatus 100 may include charger pump 137. Charger pump 137 may, for example and without limitation, be utilized to prime hydraulic pump 135. In some embodiments, charger pump 137 may be powered electrically by a second electric motor and apart from hydraulic pump 135. In some embodiments, where charger pump 137 is a manual type, charger pump 137 may be powered by electric motor 136. Hydraulic pump 135 may be used to pump fluid from one or more inlets 141 to a low pressure outlet 142′. In some embodiments, valve 115 may be coupled between hydraulic pump 135 and high pressure outlet 143. In some embodiments, hydraulic pump 135 may be operated continuously, and valve 115 may divert fluid to an outlet 142 when fluid is not routed to outlet 143. In some embodiments, one or more filters 144 may be included in BOP test apparatus 100. In some embodiments, regulator 113 may be positioned to regulate the output pressure of hydraulic pump 135 as previously described. In some embodiments, one or more pressure relief valves 145 may be positioned to, for example and without limitation, provide relief for overpressure situations.

In some embodiments, one or more of hydraulic pump 135, charger pump 137, and valve 115 may be controlled by control system 147. Control system 147 may receive inputs from control panel 111 and one or more sensors in BOP test apparatus 100. In some embodiments, control system 147 may include computer readable memory storage media to record pressures measured by digital gauge 121. In some embodiments, pressures may be recorded by an analog chart recorder. In some embodiments, control system 147 may include a telemetry system to, for example and without limitation, allow pressure readings to be transmitted to a remote site. The telemetry system may transmit information over a wired or wireless connection, including, for example and without limitation, Wi-Fi, cellular, or satellite communication links. In some embodiments, BOP test apparatus 100 may include one or more auxiliary test outlets 159 positioned to allow connection of additional pressure sensor equipment to BOP test apparatus 100 including, for example and without limitation, a control system for a drilling rig on which BOP test apparatus 100 is positioned.

In some embodiments, BOP test apparatus 100 may include one or more power electronics components, including transformer 149. Transformer 149 may transform supplied electric power to a different voltage for use with other equipment. In some embodiments, one or more 110V 60 Hz outlets 161 may be powered by transformer 149.

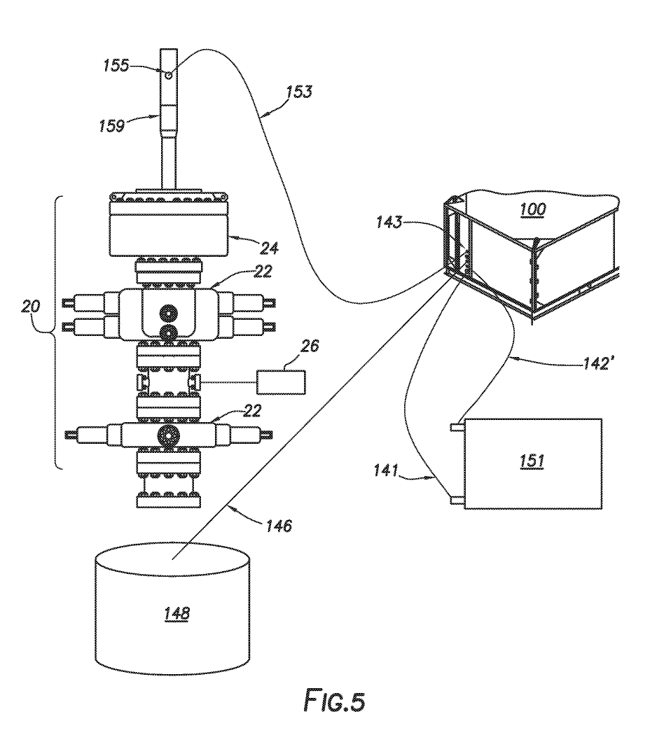

In some embodiments, as depicted in FIG. 5, BOP test apparatus 100 may be positioned in a wellsite. BOP test apparatus 100 may be transported utilizing one or more of lift points 103 or forklift pockets 105 as previously discussed.

Inlet 141 of BOP test apparatus 100 may be coupled to one or more fluid supplies, including, for example and without limitation, fluid tank 151 or any fluid reservoir. In some embodiments, high pressure outlet 143 may be coupled to test hose 153. Test hose 153 may be coupled to one or more components of BOP 20 during testing operations as described herein below. In some embodiments, clean low pressure outlet 142′ may return fluid from BOP test apparatus 100 to fluid tank 151. In some embodiments, dirty low pressure outlet 146 may dump fluid to a sump, cellar, or, as depicted in FIG. 5, disposal tank 148

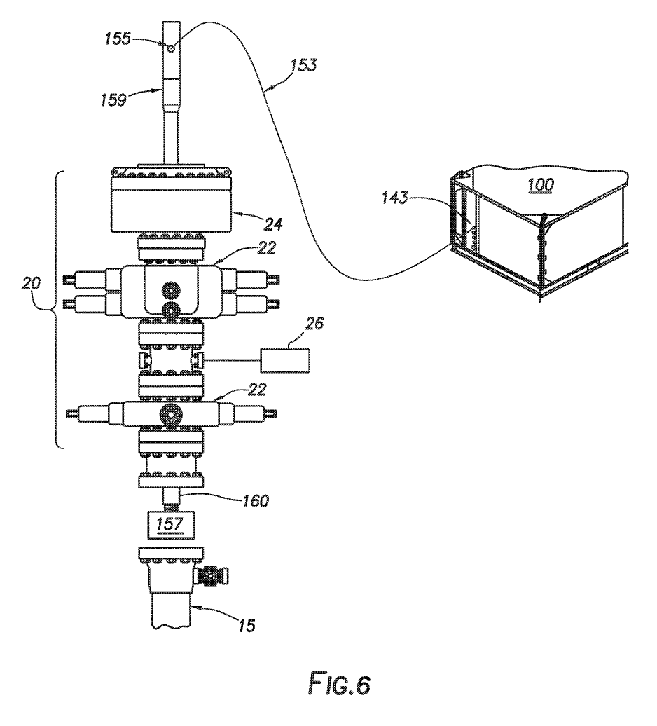

For example and without limitation, a BOP testing cycle may include testing the components of BOP 20 sequentially. BOP 20, as depicted in FIG. 6, may include one or more valves including ram blowout preventer 22 and annular blowout preventer 24. BOP 20 may be coupled to choke 26 between the components of BOP 20. In some embodiments, the testing cycle may include coupling side port entry sub 155 to BOP 20. Test plug 157 may be positioned within BOP 20 to, for example and without limitation, isolate wellbore 15 below BOP 20 from the interior of BOP 20. Test plug 157 may be coupled to test joint 160 to, for example and without limitation, position it within BOP 20.

Test hose 153 may be coupled to side port entry sub 155 of BOP 20. Pressurized fluid from BOP test apparatus 100 may be introduced into BOP 20, while the components of BOP 20, including, for example and without limitation, ram blowout preventer 22, annular blowout preventer 24, and choke 26 depicted in FIG. 5. Valves to be tested may be actuated sequentially. Digital gauge 121 as previously described may record pressure readings during the test procedure to, for example and without limitation, record and ensure proper pressure testing of the components of BOP 20. In some embodiments, pressure testing may be recorded with an external recording device such as an analog chart recorder.

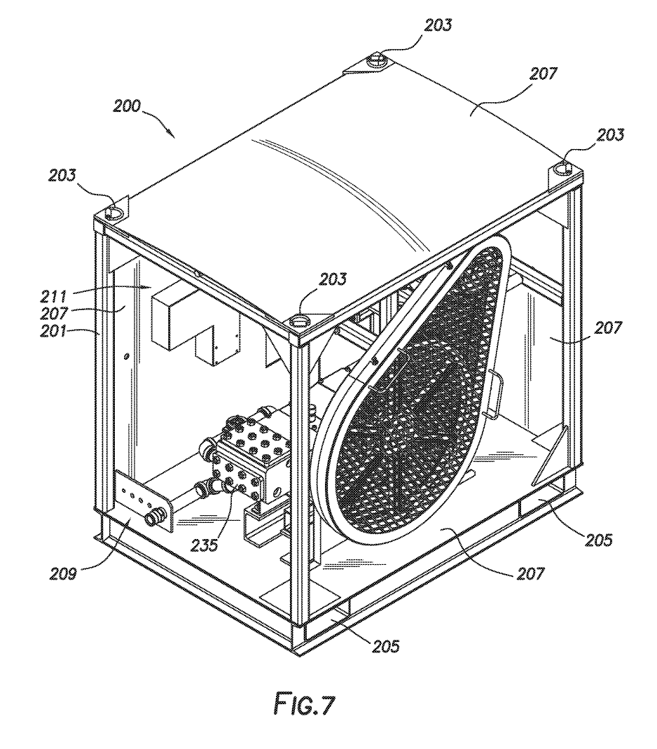

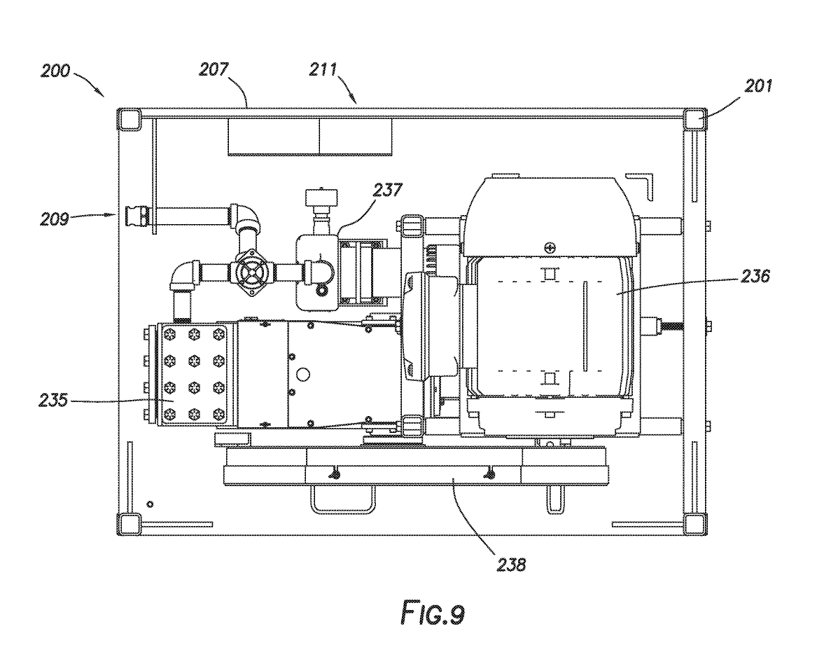

In some embodiments, as depicted in FIGS. 7-10, BOP test apparatus 200 may omit hydraulic wrench assembly 131 and thereby be made more compact. In such an embodiment, BOP test apparatus 200 may be designed to remain on the rig floor of a drilling rig. In such an embodiment, BOP test apparatus 200 may be transported with the drilling rig on a rig skid such that BOP test apparatus 200 does not need to be rigged up and down each time the rig is assembled and disassembled.

In some embodiments, BOP test apparatus 200 may include outer frame 201. In some embodiments, outer frame 201 may include one or more lift points 203 for coupling to, for example and without limitation, one or more hoisting lines for movement of BOP test apparatus 200. In some embodiments, outer frame 201 may include one or more forklift pockets 205 to, for example and without limitation, allow a forklift to lift BOP test apparatus 200. In some embodiments, outer frame 201 may be fluid tight at the bottom to, for example, contain any spills within BOP test apparatus 200.

In some embodiments, BOP test apparatus 200 may include outer walls 207 (two of which are depicted as transparent for clarity in FIG. 7). Outer walls 207 may, for example and without limitation, isolate the internal components of BOP test apparatus 200 from the surrounding environment. Outer walls 207 may, in some embodiments, include one or more access doors, control panels, or other features as discussed herein below and otherwise. In other embodiments, outer walls 207 may be removable or omitted from BOP test apparatus 200.

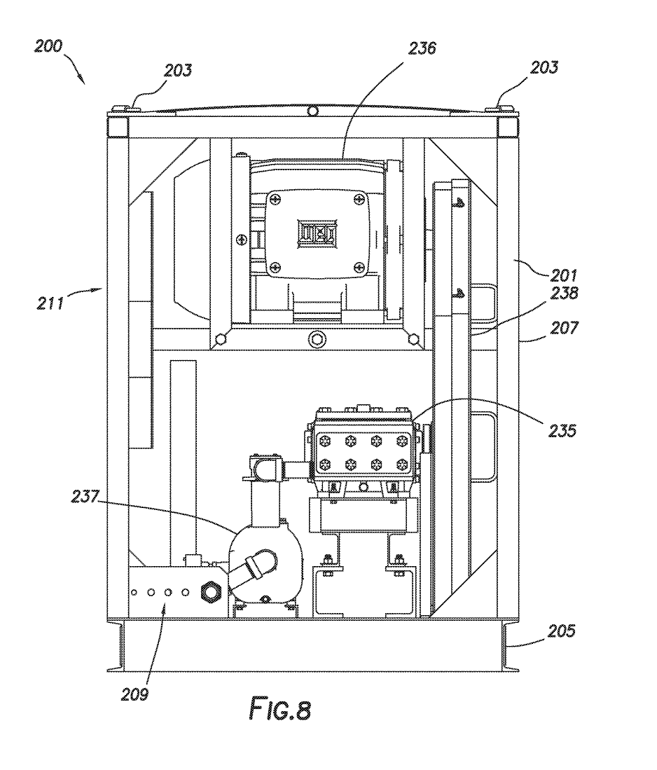

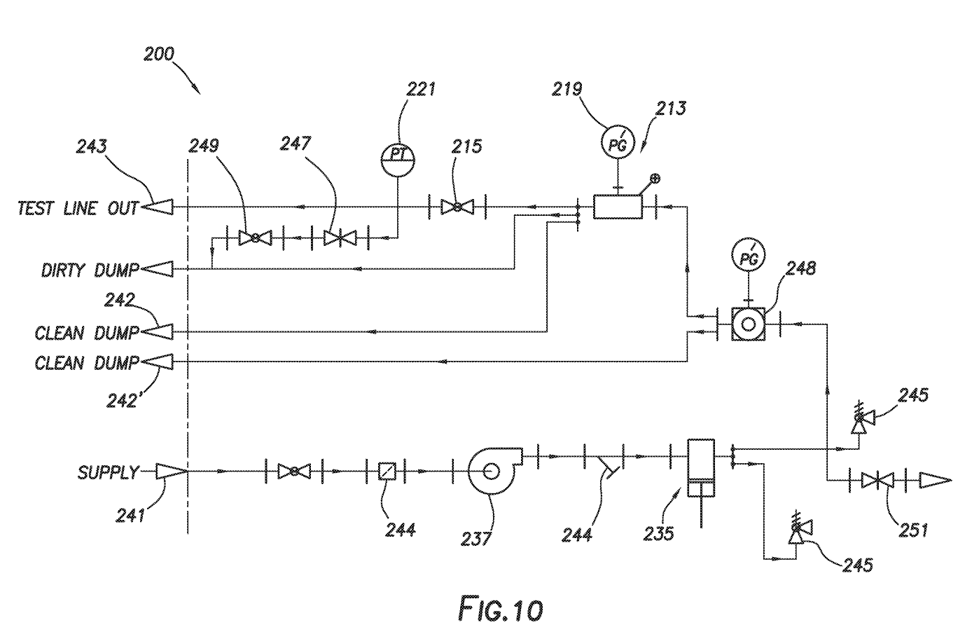

In some embodiments, as depicted in FIGS. 7 and 8 and discussed further herein below with respect to FIG. 10, BOP test apparatus 200 may include hydraulic ports 209. Hydraulic ports 209 may couple to one or more hydraulic lines for supplying fluid to BOP test apparatus 200 and hydraulic lines for routing pressurized fluid from BOP test apparatus 200.

In some embodiments, BOP test apparatus 200 may include control panel 211. Control panel 211 may include controls for controlling the operation of BOP test apparatus 200. For example and without limitation, with reference to the schematic view shown in FIG. 10, control panel 211 may include regulator 213. Regulator 213 may be used to preselect a regulated pressure for an output of BOP test apparatus 200. In some embodiments, regulator 213 may be calibrated. In some embodiments, BOP test apparatus 200 may include valve 215. Valve 215 may be fluidly coupled to allow selective fluid flow at the preselected pressure through one or more hydraulic ports 209. In some embodiments, valve 215 may be an isolation valve. In some embodiments, control panel 211 may include one or more gauges for measuring and/or displaying output pressure of BOP test apparatus 200. In some embodiments, for example and without limitation, analog gauge 219 may display an output pressure to an operator. In some embodiments, digital gauge 221 may measure output pressure of BOP test apparatus 200.

In some embodiments, BOP test apparatus 200 may include hydraulic pump 235. In some embodiments, hydraulic pump 235 may be, for example and without limitation, a triplex positive displacement pump as understood in the art. In some embodiments, hydraulic pump 235 may be powered by an electric or fossil fuel motor. Although described herein as a hydraulic pump, one having ordinary skill in the art with the benefit of this disclosure will understand that a pneumatic pump may be utilized without deviating from the scope of this disclosure. In some embodiments, hydraulic pump 235 may be driven by electric motor 236 as shown in FIGS. 7-9. Electric motor 236 may, in some embodiments, couple to hydraulic pump 235 by belt 238. In some embodiments, BOP test apparatus 200 may include charger pump 237. Charger pump 237 may, for example and without limitation, be utilized to prime hydraulic pump 235. In some embodiments, charger pump 237 may be powered electrically by a second electric motor and apart from hydraulic pump 235. In some embodiments, charger pump 237 may be powered by electric motor 236. Hydraulic pump 235 may be used to pump fluid from one or more inlets 241 to a low pressure outlet 242. In some embodiments, valve 215 may be coupled between hydraulic pump 235 and outlet 243. In some embodiments, hydraulic pump 235 may be operated continuously, and valve 215 or bypass valve 248 may divert fluid to an outlet 242′ when fluid is not routed to outlet 243. In some embodiments, one or more filters 244 may be included in BOP test apparatus 200. In some embodiments, regulator 213 may be positioned to regulate the output pressure of hydraulic pump 235 as previously described. In some embodiments, one or more pressure relief valves 245 may be positioned to, for example and without limitation, provide relief for overpressure situations. In some embodiments, one or more needle valves 247 or ball valves 249 may be positioned to divert fluid to a dirty low pressure outlet 246, which may be used to dump fluid to a sump, cellar, or disposal tank as discussed above. Needle valve 247 may also be used to discharge pressure within BOP test apparatus 200 such as, for example and without limitation, for repair if washout occurs. In some embodiments, bleed valve 251 may be positioned to, for example and without limitation, bleed fluid pressure from BOP test apparatus 200.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A BOP test apparatus comprising:
an outer frame;
a hydraulic pump, the hydraulic pump powered by an electric motor;
a charger pump, the charger pump powered by a second electric motor;
a regulator, the regulator positioned to regulate the pressure of a fluid pumped by the hydraulic pump; and
a valve, the valve positioned to open or close fluid flow from the hydraulic pump to an outlet.

2. The BOP test apparatus of claim 1, further comprising a digital pressure gauge.

3. The BOP test apparatus of claim 1, wherein the charger pump is positioned to prime the hydraulic pump.

4. The BOP test apparatus of claim 1, wherein the outer frame includes one or more lift points.

5. The BOP test apparatus of claim 1, wherein the outer frame includes one or more forklift pockets.

6. The BOP test apparatus of claim 1, wherein the hydraulic pump is powered by a first electric motor and the charger pump is powered by a second electric motor.

7. The BOP test apparatus of claim 1, wherein the hydraulic pump and charger pump are powered by an electric motor.

8. The BOP test apparatus of claim 1, further comprising a hydraulic wrench assembly including one or more hydraulic wrenches.

9. The BOP test apparatus of claim 1, further comprising a transformer, the transformer transforming supplied electric power to a different voltage for use with other equipment.

10. The BOP test apparatus of claim 1, further comprising a low pressure outlet.

11. The BOP test apparatus of claim 1, further comprising a clean low pressure outlet.

12. The BOP test apparatus of claim 1, further comprising a dirty low pressure outlet coupled to a disposal tank, sump, or cellar.

13. The BOP test apparatus of claim 1, further comprising storage for a mobile hydraulic pressure unit.

14. The BOP test apparatus of claim 1, further comprising one or more analog pressure gauges.

15. The BOP test apparatus of claim 1, further comprising a hose storage compartment.

16. The BOP test apparatus of claim 1, wherein the outlet is fluidly coupled to a side port entry sub.
